(19) United States
(12) Patent Application Publication
(10) Pub. No.: US 2006/0253735 A1
(43) Pub. Date: Nov. 9, 2006

(54) Method and system for conserving battery power of mesh points in a mesh network

(75) Inventors: Joseph Kwak, Bolingbrook, IL (US); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/371,592

(22) Filed: Mar. 9, 2006

Related U.S. Application Data
(60) Provisional application No. 60/660,762, filed on Mar. 11, 2005.

(51) Int. Cl. G06F 11/00

(52) U.S. Cl. 714/12

(57) ABSTRACT

A method and system for conserving power of battery-powered mesh points (MPs) in a mesh network are disclosed. In one embodiment, a centralized controller is provided in the mesh network. Each of the MPs signal information associated with conserving MP battery power and provide indications of battery power levels associated with the respective MPs to the centralized controller. The centralized controller optimizes the configuration of the mesh network based on the signaling information for conserving MP battery power and the battery power level indications. In an alternate embodiment, each of the MPs individually monitor traffic flowing through the respective MP and a level of battery power associated with the respective MP. Each of the MPs determine whether to activate a power saving function associated with the respective MP and signal information associated with conserving MP battery power to neighboring MPs in the mesh network.

### CROSS REFERENCE TO RELATED APPLICATION

This application claims the benefit of U.S. Provisional Application No. 60/660,762 filed Mar. 11, 2005, which is incorporated by reference as if fully set forth.

### FIELD OF INVENTION

The present invention is related to a wireless mesh network which includes a plurality of battery-powered mesh points (MPs). More particularly, the present invention is related to a method and system for conserving the battery power of the (MPs) by implementing a power save function.

### BACKGROUND

Many schemes have been developed for saving battery power in cellular wireless communication system components. For example, a typical scheme for conserving battery power uses an idle mode to provide low duty-cycle background monitoring of paging channels. However, IEEE 802.11-based wireless local area network (WLAN) devices do not efficiently conserve battery power. This is due to the basic design principles of the radio multiple access scheme chosen for WLANs, especially with respect to the receive mode operation.

Instantaneous power consumption is typically higher in a transmit mode than in a receive mode. However, the receive mode is the overall determining factor for long-term power-consumption in WLAN devices because distributed coordination function (DCF) or enhanced distributed channel access (EDCA)-based WLAN devices need to listen to all incoming packets, regardless of the destination of the incoming packets. During the receive mode operation, WLAN devices monitor signal presence on a channel. If a signal is detected, the WLAN devices try to decode a preamble and a header of a receiving data packet. If the destination address of the packet matches the address of the device, the devices decode the packet. Otherwise, the packet is discarded.

In some situations, the WLAN must deploy battery-powered MPs and mesh access points (MAPs), such as for military and/or emergency situations. In such situations, it is desirable to provide a method and system for ensuring long battery-life and power-efficient operations for the battery-powered devices.

### SUMMARY

The present invention is a method and system for conserving power of battery-powered MPs in a mesh network. In one embodiment, a centralized controller is provided in the mesh network. Each of the MPs signal information associated with conserving MP battery power and provide indications of battery power levels associated with the respective MPs to the centralized controller. The centralized controller optimizes the configuration of the mesh network based on the signaling information for conserving MP battery power and the battery power level indications. In an alternate embodiment, each of the MPs individually monitor traffic flowing through the respective MP and a level of battery power associated with the respective MP. Each of the MPs determine whether to activate a power saving function associated with the respective MP and signal information associated with conserving MP battery power to neighboring MPs in the mesh network.

### BRIEF DESCRIPTION OF THE DRAWINGS

A more detailed understanding of the invention may be had from the following description, given by way of example and to be understood in conjunction with the accompanying drawings wherein:

FIG. 1 shows a wireless mesh network in accordance with the present invention;

FIG. 2 is a flow diagram of a process for saving battery power of MPs using a centralized controller in the mesh network of FIG. 1;

FIG. 3 is a flow diagram of an alternate process for saving battery power of MPs in the mesh network of FIG. 1 without the use of a centralized controller;

FIG. 4 is a block diagram of an exemplary centralized controller used in the wireless mesh network of FIG. 1; and

FIG. 5 is a block diagram of an exemplary MP used in the wireless mesh network of FIG. 1.

### DETAILED DESCRIPTION OF THE PREFERRED EMBODIMENTS

Hereafter, the terminology “wireless transmit/receive unit” (WTRU) includes but is not limited to a user equipment (UE), a mobile station, a fixed or mobile subscriber unit, a pager, or any other type of device capable of operating in a wireless environment.

The present invention is applicable to any type of wireless mesh network including, but not limited to, IEEE802.11x, IEEE802.15, Bluetooth™, HIPERLAN/2 or the like.

The features of the present invention may be incorporated into an integrated circuit (IC) or be configured in a circuit comprising a multitude of interconnecting components.

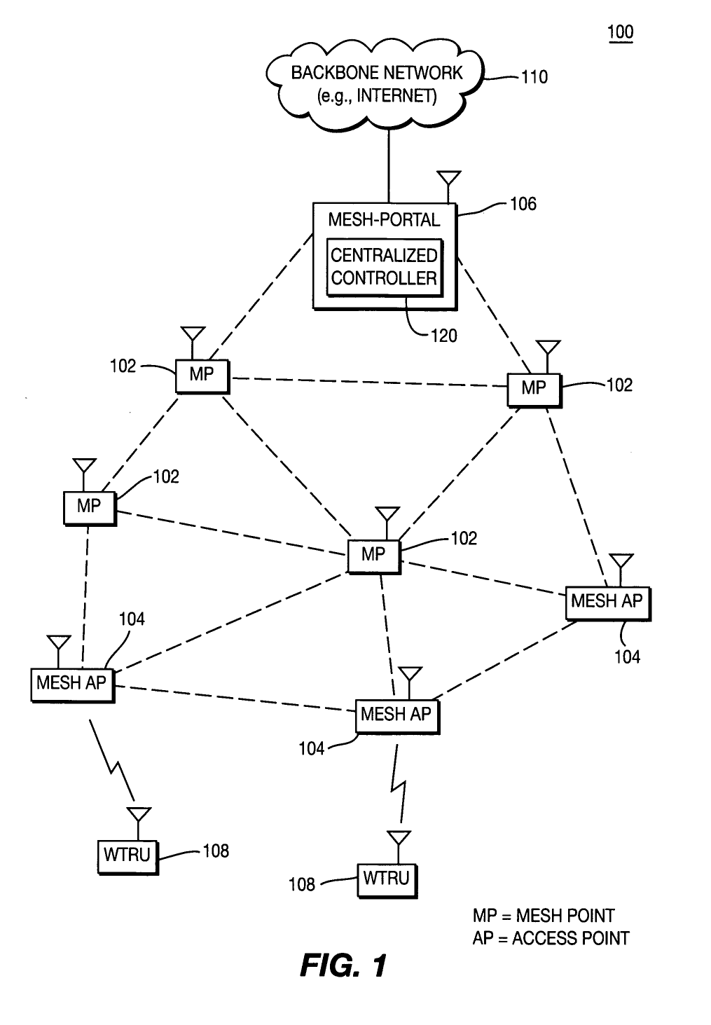

FIG. 1 shows a wireless mesh network 100 in accordance with the present invention. The mesh network 100 includes a plurality of MPs 102, a plurality of mesh access points (APs) 104, a mesh portal 106 and a plurality of WTRUs 108. The MPs 102 perform as basic forwarding and relaying nodes in the mesh network 100. The MPs 102 receive traffic on incoming links and forward it on outgoing links. The mesh APs 104 are also MPs with an interface to provide a radio access to the WTRUs 108 to provide WLAN services in a certain geographic area. The WTRUs 108 communicate with another WTRU in the mesh network or a backbone network 110, (such as the Internet), via the mesh APs 104 and the mesh portal 106.

The WTRUs 108 are typically unaware of the presence of the mesh network 100. The mesh APs 104 forward the traffic generated by the WTRUs 108 to another mesh AP 104 or the mesh portal 106 by relaying the traffic via intermittent MPs 102. The mesh portal 106 provides connectivity to the backbone network 110 for the mesh network 100. Thus, the mesh portal 106 acts as an MP with a special interface to the backbone network 110.

The MPs 102, the mesh APs 104 and the mesh portal 106 are battery-powered devices. The present invention provides a method and system for saving the battery power of these battery-powered devices. Hereinafter, the terminology “mesh point” (MP) and a reference numeral 102 will be used to refer to the MPs 102, the MAPs 104 and the mesh portal 106, collectively.

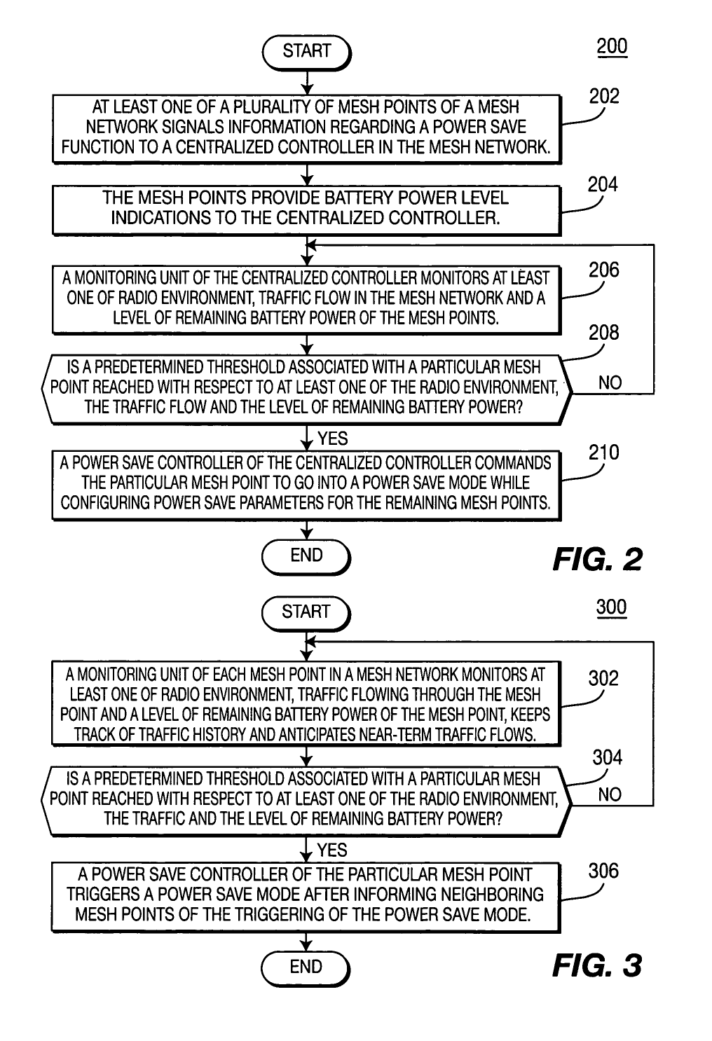

FIG. 2 is a flow diagram of a process 200 for saving battery power of MPs in a mesh network in accordance with one embodiment of the present invention. In accordance with this embodiment, a centralized controller 120 is provided in the mesh network 100. The centralized controller 120 may reside anywhere in the mesh network. For example, the centralized controller 120 may reside in the mesh portal 106, as shown in FIG. 1. The centralized controller 120 controls and assigns all of the settings related to power saving, (e.g., routing paths, frequencies, or the like), for all of the MPs 102. The MPs 102 are under the complete and exclusive control of the centralized controller 120.

In step 202, at least one of a plurality of MPs 102 of the mesh network 100 signals information regarding a power save function to the centralized controller 120. The information regarding the power save function includes at least one of a power source, a power save capability, a power save requirement, power saving features implemented by the MP 102 and intended power saving actions. In step 204, the MPs 102 periodically, or when polled by the centralized controller 120, provide battery power level indications to the centralized controller 120. The information regarding the power save function and the battery power level indications are preferably sent by means of layer 2 (L2) or layer 3 (L3) signaling messages, such that the centralized controller 120 recognizes the requirements of the MPs 102 for battery power savings.

The information is preferably included in a capability field in medium access control (MAC) layer messages, such as association, authentication or probe request messages. Alternatively, the information may be included in an information element (IE) of the L2 or L3 signaling messages that may be included in any data, control or management messages which are exchanged on-demand or periodically.

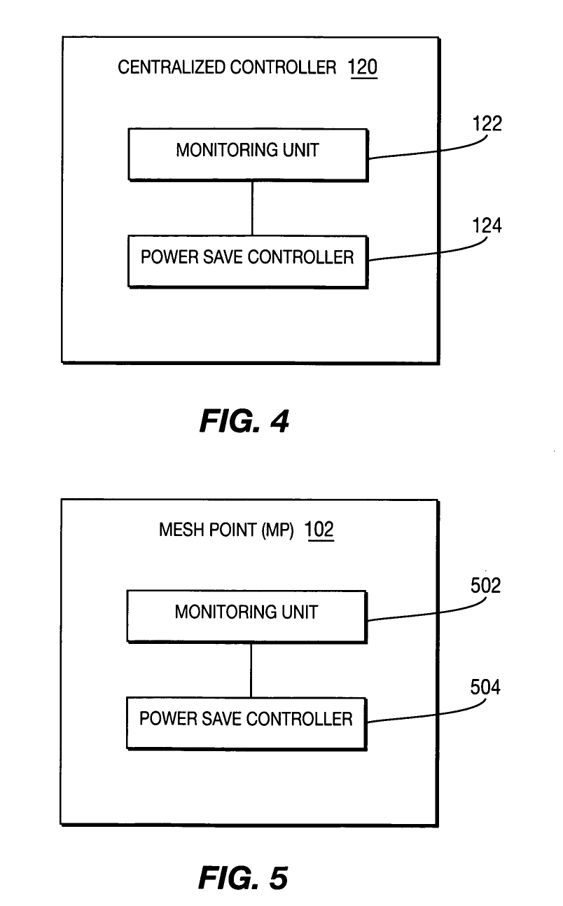

Referring to FIGS. 2 and 4, the centralized controller 120 includes a monitoring unit 122 and a power save controller 124. The monitoring unit 122 of the centralized controller 120 monitors at least one of radio environment, traffic flow in the mesh network 100 and a level of remaining battery power of the MPs 102 (step 206). The power save controller 124 of the centralized controller determines whether a predetermined threshold associated with a particular MP 102 is reached with respect to at least one of the radio environment, the traffic flow and the level of remaining battery power of the MPs 102 (step 208). If the predetermined threshold is reached, the power save controller 124 of the centralized controller 120 commands the particular MP 102 to go into a power save mode while configuring power save parameters for the remaining MPs 102 (step 210). The MPs 102 in the power save mode enter into a doze state and periodically wake up at certain configured wake-up times to listen to beacons to check if the centralized controller 120 has issued a page to deactivate the power save mode of the MPs 102.

The power save controller 124 of the centralized controller 120 assigns parameters affecting the power save state of the MPs 102, and the actions of the MPs 102 during the power save mode are controlled by the parameters.

The power save parameters may be configured to control the frequency channels on which the MPs operate. The MPs 102 may be able to operate with multiple radios. In such case, the MPs 102 are able to transmit and receive on more than one frequency channel at the same time. For example, the MP 102 may use a dual-radio with IEEE 802.11g radio and additional IEEE 802.11a radio for backhaul, or the MP 102 may use one IEEE 802.11g radio for a basic service set (BSS) and two additional IEEE 802.11a radios for backhaul.

The power save function is implemented by selectively turning on and off at least one frequency channel during the power save mode. The MPs 102 may have separate modems for each frequency channel or some parts of the modems may be shared for multiple frequency channels. In either case, by turning off all or part of the modem, the battery power can be saved. In a non-power save mode, an MP 102 may transmit and receive on all channels, while in a power save mode, the MP 102 transmits and receives only on a subset of the frequency channels, (i.e., less than its radio frequency (RF) hardware actually permits). The centralized controller 120 may designate a specific frequency channel to be turned off.

Alternatively, the power save function may be implemented by time coordination among the MPs 102. The power save controller 124 of the centralized controller 120 sets up scheduled service period intervals when to receive and when to send data through the mesh network on particular links, (the centralized controller 120 sets up an active period and the doze period for the MPs 102). During the scheduled doze period, all of the MPs 102 power down and no data traffic is transmitted. The centralized controller 120 may adjust the ratio of the doze period to an active period in a flexible manner by considering a trade-off between capacity on the mesh network 100 and delay of the traffic.

In a preferred embodiment, each of the MPs 102 is allocated an individual service time period. Thus, the centralized controller 120 allocates service periods to individual MPs 102 while coordinating the service periods amongst all power-saving MPs 102 in the mesh network 100. For example, “coordination” of these individual service periods may be implemented by three (3) MPs 102 in a daisy chain where a first one of the MPs 102 can transmit only during 0-100 ms, and sleeps from 100 ms-1000 ms, a second one of the MPs 102 can only receive from 0-100 ms, transmit from 100 ms-200 ms, and sleep from 200-1000 ms, and finally, a third one of the MPs 102 receives from 100 ms-200 ms, and sleeps from 0-100 ms and 200 ms-1000 ms. This process is repeated each second, (i.e., 1000 ms).

The centralized controller 120 may set the algorithms for deciding on routing paths and connectivity through the mesh network in accordance with power-saving needs of the MPs. The centralized controller 120 assigns a routing path and data packet forwarding patterns through the mesh network 100 in a way that the number of MPs in a power save mode involved in the routing path is minimized. The MPs not included in the routing path may go into a doze state during which the MPs wake up only to check for changes in the configured routing path. The centralized controller 120 may determine the routing path considering the battery power level indication from the MPs 102.

The centralized controller 120 may command the MPs 102 to aggregate data packets and transmit them at the same transmit opportunity during the power save mode. This scheme reduces the effective receive and transmit durations of incoming and outgoing data streams and as such to save battery power. The MPs 102 store the incoming data packets temporarily in a buffer instead of forwarding the data packets each and every time the MPs 102 receive them and burst them out at the same time to maximize the usage of a certain allocated transmit opportunity. This scheme minimizes the number of contention for medium access and keeps RF receive and transmit time low. The centralized controller 120 sets parameters considering delay and required memory. This scheme may be applied to both real time traffic and non-real time traffic.

In an alternate embodiment, the present invention may be implemented in a distributed mode. FIG. 3 is a flow diagram of a process 300 for saving battery power of the MPs 102 without using the centralized controller 120 in accordance with the present invention. The MPs 102 make decisions on all power save parameters, (such as, but not limited to, frequency channels to use, service period intervals, routing paths, and aggregation of data packets), on their own based on observation of the radio environment, perceived traffic flows, anticipated requirements, battery power level, or the like. The MPs 102 are completely autonomous and entering into the power save mode is under the decision of each individual MP 102.

Referring to FIGS. 3 and 5, an MP 102 includes a monitoring unit 502 and a power save controller 504. The monitoring unit 502 of each MP 102 monitors at least one of radio environment, traffic flowing through the MP 102, (i.e., the amount and/or nature, (e.g., real time vs. non-real time), of the traffic), and a level of remaining battery power of the MP 102, keeps track of traffic history and anticipates near-term traffic flows (step 302).

The power save controller 504 of the MP 102 controls actions of the MPs 102 during a power save mode. The power save controller 504 of the MP 102 determines whether a predetermined threshold associated with a particular MP 102 is reached with respect to at least one of the radio environment, the traffic and the level of remaining battery power (step 304)

If the predetermined threshold is reached, (e.g., traffic below a certain level or the battery power level reaching a certain level), the power save controller 504 of the particular MP 102 triggers a power save mode after informing neighboring MPs of the triggering of the power save mode (step 306) such as by broadcasting a null-data frame.

During the power save mode, the MP 102 implements one or more schemes for power savings as stated hereinabove with respect to the first embodiment. The MP 102 may selectively turn on and off at least one frequency channel to save the battery power. The MP 102 may enter into a doze state in accordance with the service period interval agreed by the MPs 102, which specifies timing to go into a doze state and to wake up. The MP 102 may determine the routing path in a way that the number of MPs in a power save mode included in the routing path is minimized. The MPs 102 may temporarily store incoming data packets in a buffer and send aggregated data packets at the same time to maximize usage of a given transmit opportunity.

The MP 102 may negotiate with neighbor MPs for the operational changes, (such as operating frequency channel, scheduled service period interval, a routing path and aggregation of traffic data), or may simply announce the operational changes.

It should be noted that although the present invention is described with reference to L2 and/or L3 signaling, it can be implemented with any ISO layer of signaling. For example, a protocol such as CAPWAP RFC would be signaled over UDP/IP, (i.e., at L5). Furthermore, signaling over SNMP or at the application layer using a proprietary management software or firmware may be implemented.

Although the features and elements of the present invention are described in the preferred embodiments in particular combinations, each feature or element can be used alone without the other features and elements of the preferred embodiments or in various combinations with or without other features and elements of the present invention.

What is claimed is:

1. In a mesh network including a plurality of battery-powered mesh points (MPs) and a centralized controller, a method for conserving the battery power of the MPs, the method comprising:
(a) the MPs signaling information associated with conserving MP battery power to the centralized controller or to peer MPs;
(b) the MPs providing indications of battery power levels associated with the respective MPs to the centralized controller or to peer MPs; and
(c) the centralized controller or MPs optimizing the configuration of the mesh network based on the signaling information for conserving MP battery power and the battery power level indications.

2. The method of claim 1 further comprising:
(d) the centralized controller activating a power saving function in at least one of the MPs.

3. The method of claim 1 further comprising:
(d) the centralized controller coordinating the MPs to operate in a power saving mode during predetermined time periods.

4. The method of claim 1 wherein the centralized controller commands unused MPs to activate a power saving function.

5. The method of claim 1 wherein the centralized controller resides in a mesh portal connected to a backbone network.

6. The method of claim 5 wherein the backbone network is the Internet.

7. The method of claim 1 wherein the centralized controller configures the mesh network to minimize the number of MPs that do not have a power saving function activated.

8. The method of claim 2 wherein the activated power saving function is deactivated on a periodic basis such that the MP can listen for mesh beacons to determine whether the centralized controller or a peer MP desires to assign the MP to a routing path.

9. The method of claim 1 further comprising:
(d) at least one of the MPs signaling information associated with conserving MP battery power to another MP in the mesh network.

10. The method of claim 9 wherein the information signaled to the other MP indicates an intended power saving action.

11. The method of claim 9 wherein the information signaled to the other MP includes MP doze/awake cycle timing information.

12. The method of claim 1 wherein the information associated with conserving MP battery power includes at least one of a power source, a power save capability, a power save need, power saving features implemented by the MP and intended power saving actions.

13. The method of claim 1 wherein the information associated with conserving MP battery power is sent via layer 2 (L2) or layer 3 (L3) signaling.

14. The method of claim 1 wherein the information associated with conserving MP battery power is included in a capability field in a medium access control (MAC) header.

15. The method of claim 1 wherein the information associated with conserving MP battery power is sent in response to a request from the centralized controller.

16. The method of claim 1 wherein the information associated with conserving MP battery power is sent from the MPs to the centralized controller on a periodic basis.

17. The method of claim 1 wherein at least one of the MPs is configured to operate on two frequency channel s but conserves battery power by turning off at least one frequency channel to save battery power.

18. The method of claim 1 wherein at least one of the MPs enter a doze state to conserve battery power in accordance with the service period interval.

19. The method of claim 18 wherein the service period interval is negotiated between the MP and the centralized controller.

20. In a mesh network including a plurality of battery-powered mesh points (MPs), a method for conserving the battery power of the MPs, the method comprising:
(a) each of the MPs individually monitoring traffic flowing through the respective MP and a level of battery power associated with the respective MP;
(b) each of the MPs determining whether to activate a power saving function associated with the respective MP; and
(c) the MP signaling information associated with conserving MP battery power to neighboring MPs in the mesh network.

21. The method of claim 20 wherein the information associated with conserving MP battery power is sent by layer 2 (L2) or layer 3 (L3) signaling.

22. The method of claim 20 wherein the information associated with conserving MP battery power is included in a capability field in a medium access control (MAC) header.

23. A power efficient mesh network comprising:
(a) a plurality of battery-powered mesh points (MPs); and
(b) a centralized controller for conserving the battery power of the MPs, wherein the MPs signal information associated with conserving MP battery power and provide indications of battery power levels associated with the respective MPs to the centralized controller, and the centralized controller optimizes the configuration of the mesh network based on the signaling information for conserving MP battery power and the battery power level indications.

24. The mesh network of claim 23 wherein the centralized controller activates a power saving function in at least one of the MPs.

25. The mesh network of claim 23 wherein the centralized controller coordinates the MPs to operate in a power saving mode during predetermined time periods.

26. The mesh network of claim 23 wherein the centralized controller commands unused MPs to activate a power saving function.

27. The mesh network of claim 23 further comprising:
a mesh portal in which the centralized controller is incorporated therein, wherein the mesh network provides wireless transmit/receive units (WTRUs) with access to a backbone network via the mesh portal.

28. The mesh network of claim 27 wherein the backbone network is the Internet.

29. The mesh network of claim 23 wherein the centralized controller configures the mesh network to minimize the number of MPs that do not have a power saving function activated.

30. The mesh network of claim 24 wherein the activated power saving function is deactivated on a periodic basis such that the MP can listen for mesh beacons to determine whether the centralized controller desires to assign the MP to a routing path.

31. The mesh network of claim 23 wherein at least one of the MPs signals information associated with conserving MP battery power to another MP in the mesh network.

32. The mesh network of claim 31 wherein the information signaled to the other MP indicates an intended power saving action.

33. The mesh network of claim 31 wherein the information signaled to the other MP includes MP doze/awake cycle timing information.

34. The mesh network of claim 23 wherein the information associated with conserving MP battery power includes at least one of a power source, a power save capability, a power save need, power saving features implemented by the MP and intended power saving actions.

35. The mesh network of claim 23 wherein the information associated with conserving MP battery power is sent by layer 2 (L2) or layer 3 (L3) signaling.

36. The mesh network of claim 23 wherein the information associated with conserving MP battery power is included in a capability field in a medium access control (MAC) header.

37. The mesh network of claim 23 wherein the information associated with conserving MP battery power is sent in response to a request from the centralized controller.

38. The mesh network of claim 23 wherein the information associated with conserving MP battery power is sent from the MPs to the centralized controller on a periodic basis.

39. The mesh network of claim 23 wherein at least one of the MPs is configured to operate on two frequency channel s but conserves battery power by turning off at least one frequency channel to save battery power.

40. The mesh network of claim 23 wherein at least one of the MPs enter a doze state to conserve battery power in accordance with the service period interval.

41. The mesh network of claim 40 wherein the service period interval is negotiated between the MP and the centralized controller.

42. In a power efficient mesh network, a plurality of battery-powered mesh points (MPs) for routing traffic, each MP comprising:
(a) a monitoring unit configured to monitor traffic flowing through the respective MP and a level of battery power associated with the respective MP; and
(b) a power save controller, wherein the respective MP determines whether to activate a power save function controlled by the power save controller and signal information associated with conserving MP battery power to neighboring MPs in the mesh network.

43. The MP of claim 42 wherein the information associated with conserving MP battery power is sent by layer 2 (L2) or layer 3 (L3) signaling.

44. The MP of claim 42 wherein the information associated with conserving MP battery power is included in a capability field in a medium access control (MAC) header.

45. In a power efficient mesh network, a plurality of battery-powered mesh points (MPs) for routing traffic, each MP including an integrated circuit (IC) comprising:
(a) a monitoring unit configured to monitor traffic flowing through the respective MP and a level of battery power associated with the respective MP; and
(b) a power save controller, wherein the respective MP determines whether to activate a power save function controlled by the power save controller and signal information associated with conserving MP battery power to neighboring MPs in the mesh network.

46. The IC of claim 45 wherein the information associated with conserving MP battery power is sent by layer 2 (L2) or layer 3 (L3) signaling.

47. The IC of claim 45 wherein the information associated with conserving MP battery power is included in a capability field in a medium access control (MAC) header.

48. In a mesh network including a plurality of battery-powered mesh points (MPs), an MP configured for conserving battery power, the MP comprising:
a monitoring unit, the monitoring unit configured for monitoring the power requirements and the remaining battery power of the MP; and
a power save controller, the power save controller configured for triggering a power save mode if the power requirements exceed a predetermined threshold.

49. The MP of claim 48 wherein the predetermined threshold is based on the remaining battery power.

50. The MP of claim 48 wherein the power requirements include at least one of radio environment, and traffic flowing through the MP.

51. The MP of claim 48 wherein the monitoring unit is further configured for storing the traffic history and anticipating near term traffic flows.

52. The MP of claim 51 wherein the power requirements include the anticipated near term traffic flows.

53. The MP of claim 48 wherein triggering a power save mode includes notifying neighboring MPs of the triggering of the power save mode.

54. The MP of claim 53 wherein the MP notifies the neighboring MPs of the triggering of the power save mode by sending a null-data frame.

55. The MP of claim 48 wherein the power save controller is further configured to activate the MP at a predetermined time in order to listen to beacons.

56. The MP of claim 55 wherein the MP deactivates at the end of a service period.

57. The MP of claim 48 wherein the power save controller is further configured for activating the MP when the MP has traffic to transmit.
